(19) United States
(12) Patent Application Publication
(10) Pub. No.: US 2010/0115021 A1
(43) Pub. Date: May 6, 2010

(54) Method for Generating a User Interface for Enabling Access to Data on a Server

(75) Inventors: Seh Eing LIM, Singapore (SG); Jin Foong LUI, Singapore (SG); Xin WU, Singapore (SG); Teck Chee LEE, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd, Singapore (SG)

(21) Appl. No.: 12/264,429

(22) Filed: Nov. 4, 2008

(51) Int. Cl. G06F 15/16

(52) U.S. Cl. 709/203

(57) ABSTRACT

There is provided a method for generating a user interface for enabling access to data on a server. The method comprises updating metadata in a metadata server, the metadata server being functionally connected to the server; processing the metadata on the metadata server; sending a request to the server to perform a task; and generating the user interface on a client device based on the processed metadata for enabling access to data on the server. The user interface may preferably be used to send the request to the server. The task being performed by the server may include, for example, browsing a collection of files, organizing files, selecting files, editing files, uploading files, downloading files and so forth.

### FIELD OF THE INVENTION

The invention relates to the field of user interfaces. In particular, the invention relates to a method for generating a user interface for enabling access to data on a server.

### BACKGROUND OF THE INVENTION

Many users store data such as media files, image files, or audio files on devices. The users typically wish to access the aforementioned data without any inconvenience even when the stored data is voluminous. It would be frustrating for the users to encounter difficulties when attempting to access the stored data.

The type of devices may include, for example, mobile phones, Personal Digital Assistants (PDAs), portable media players, computers, any computing device and so forth. As the collection of files grow, the users typically manually organize their files on the device using file management applications running on the device.

To satisfy the need for increased storage of data, many online data sharing sites allow users to upload data for storage so that the users do not have to compromise a compact form factor for their device in order to possess higher storage capacity. In addition, these online data sharing sites also allow users to access their data regardless of device as long as the device is technically able to access the online data sharing sites. However, to manage the uploaded files or files stored on the server, the device has to be continually connected to the online data sharing sites either through either a wireless or a wired connection. It is desirable that the widespread proliferation of online data sharing sites still allows the uploaded data from the various online data sharing sites to be easily accessible by the user despite the voluminous amount of data stored at the various online data sharing sites.

Reference in the specification is made to U.S. Pat. No. 6,928,433 titled “Automatic Hierarchical Categorization of Music By Metadata” which is assigned to Creative Technology Ltd. The reference is made in relation to a media file management application that will be mentioned in the section titled “Detailed Description of the Embodiments”.

### SUMMARY OF THE INVENTION

There is provided a method for generating a user interface for enabling access to data on a server. The method comprises updating metadata in a metadata server, the metadata server being functionally connected to the server; processing the metadata on the metadata server; sending a request to the server to perform a task; and generating the user interface on a client device based on the processed metadata for enabling access to data on the server. The user interface may preferably be used to send the request to the server. The task being performed by the server may include, for example, browsing a collection of files, organizing files, selecting files, editing files, uploading files, downloading files and so forth.

It is preferable that processing the metadata comprises analysing the metadata on the metadata server. Analysing the metadata may comprise determining a data file format such as, for example, audio file, image file, video file and so forth.

Preferably, analysing the metadata enables categorization of data into a hierarchy in accordance with branches of a directory tree as presented in the user interface.

The client device may be selected from, for example, portable media player, mobile phone, Personal Digital Assistant (PDA), computing device and so forth.

It may be preferable for the server to be separable into at least one data server and at least one metadata server.

In addition, the method may further include consuming the data based on a combination of a pre-defined protocol and a hardware/software configuration of the client device.

It may be preferable that updating the metadata in the metadata server is either a push process by the server or a pull process by the metadata server.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows an overview of a method for generating a user interface according to a first embodiment;

FIG. 2 shows a representation of the user interface of FIG. 1;

FIGS. 3a and 3b show variations of the user interface of FIG. 1; and

FIG. 4 is a flow chart outlining the method of FIG. 1.

### DETAILED DESCRIPTION OF THE EMBODIMENTS

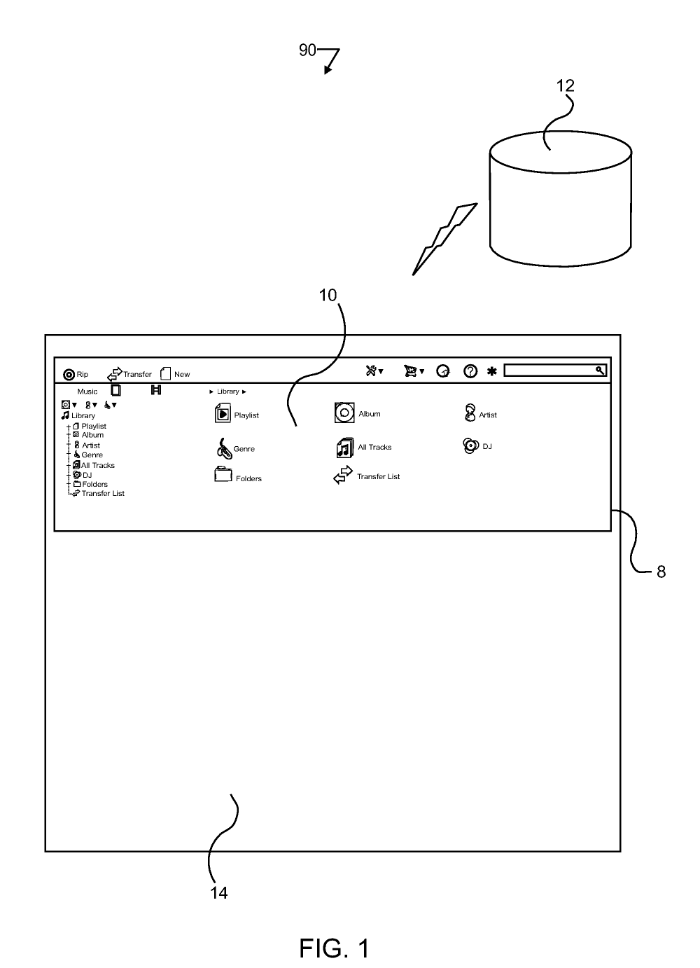

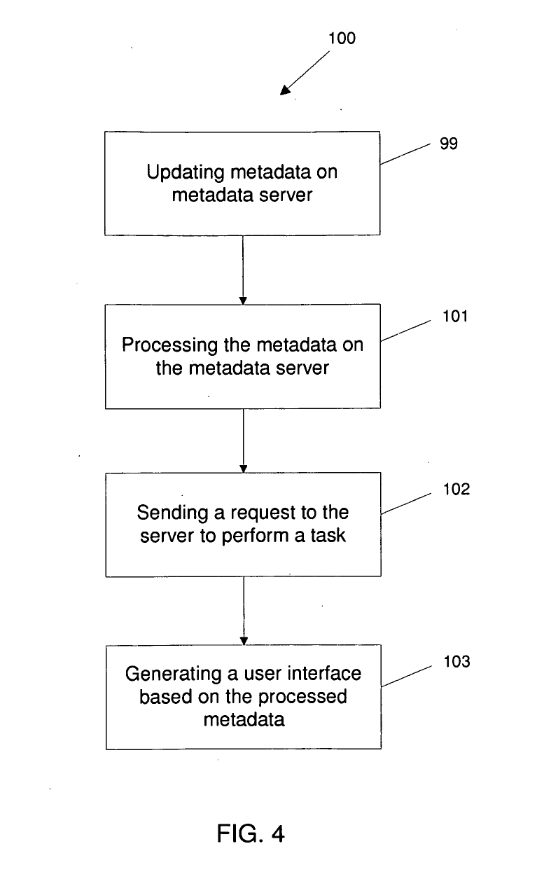

FIG. 4 illustrates a flow chart of a method 100 for generating a user interface 10 for enabling access to data on a server 12 according to a first embodiment of the invention. FIG. 1 illustrates a system 90 where the method 100 may be employed. With reference to FIG. 1, the user interface 10 may formatted for display on a display 8 on a client device 14. The server 12 may be, for example, a computer, a program residing on a computer, a remote network site or any storage means. While the server 12 is shown to be a single unit in FIG. 1, it should be noted that the server 12 can be separable into at least one metadata server and at least one data server.

The metadata server may contain all metadata of data from the at least one data server. When the at least one metadata server and at least one data server are functionally linked, a user would not be able to distinguish a composition of servers being used. The metadata server may obtain and process new metadata whenever new data is input into the at least one data server. The provision of new metadata to the metadata server may be either a push process (where the data server transmits any new metadata for new data to the metadata server) or a pull process (where the metadata server periodically/continually checks whether new data resides in the data server and consequently sends a request to the data server to transmit any new metadata). The use of a plurality of data servers would be similar to an instance when a plurality of online storage facilities are in use by the user.

The client device 14 may be, for example, a portable media player, a mobile phone, an application running on a processor-based device and so forth. In a non-limiting embodiment, the invention will now been described with reference to the portable media player. It should be noted that the invention may also be applied in other areas such as, desktop/server computers, computing devices and so forth. However, it should be appreciated that the method 100 is most advantageously employed in devices 14 with low-end processing capability as the method 100 does not require the device 14 to carry out data processing in relation to the method 100. The device 14 is preferably wirelessly connected to the server 12 via a network connection.

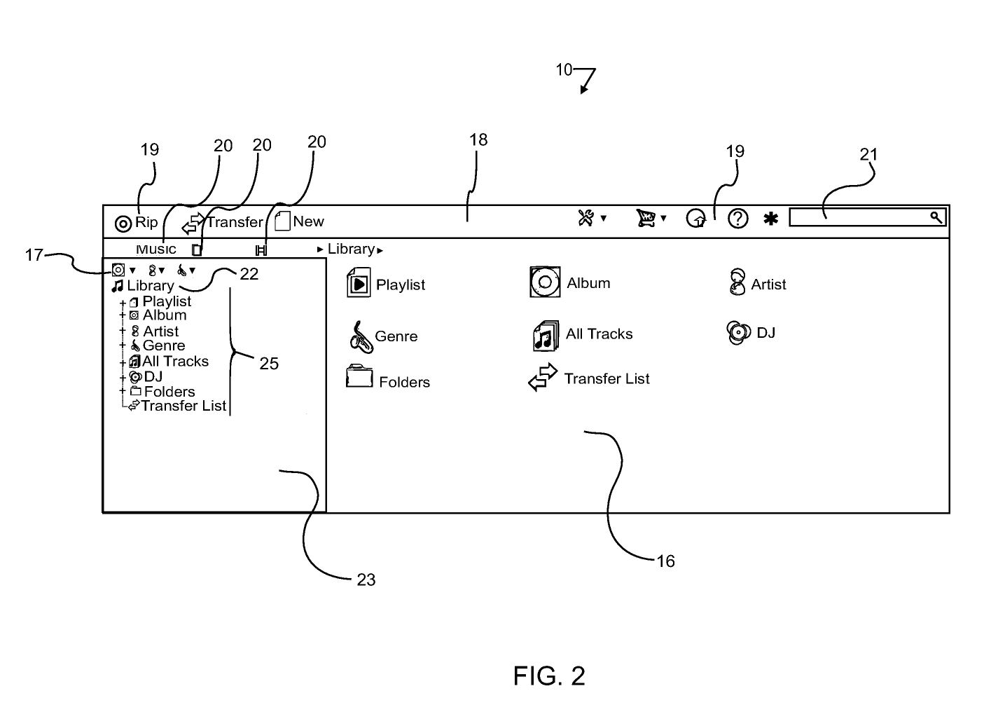

FIG. 2 shows a non-limiting representation of the user interface 10 which appears on the display 8 on the client device 14. The user interface 10 may comprise a secondary window 16, a task selection bar 18 and a plurality of modal tabs 20 for selecting modes for viewing in a primary window 23. The secondary window 16 may be for presentation of an expanded view of contents of a branch 25 of a directory tree 22. The contents of the branch 25 of the directory tree 22 may also be shown in a contents bar 17 in the primary window 23. As such, the user may select contents of the branch 25 of the directory tree 22 either from the secondary window 16 or the contents bar 17.

The task selection bar 18 may consist of a selection (plurality) of action buttons 19. The action buttons 19 may each be represented by either a graphical icon or a literary description. The action buttons 19 may be grouped in accordance with, for example, a user's preferences, the type of task being performed, how each task is related to each other and so forth. The action buttons 19 in the task selection bar 18 may include, for example, browsing a collection of files, organizing files, selecting files, editing files, uploading files, downloading files and so forth.

In a non-limiting example, for tasks relating to file access, related action buttons 19 like transfer of files, editing or creating a folder are grouped together in a sequential manner to either aid or guide the user to perform the desired task(s) quickly and efficiently. The action buttons 19 may also provide the option for the user to go online to download a file. Furthermore, a query form field 21 is provided in the task bar 18 to enable the user to enter text to search for a specific file.

Each modal tab 20 may have a directory tree 22 and each modal tab 20 may be determined by a data file format of each data file stored in the directory tree 22. The data files may include, for example, audio files, image files, video files, non-media files or the like. Each directory tree 22 may consist a list of branches 25 that are relevant to the directory tree 22 (which may be dependent on data file format of data files). When a particular modal tab 20 is selected, the set of branches 25 in the directory tree 22 is displayed. The branches 25 may be presented in a list view format in the primary window 23 (as shown). A detailed description relating to how the directory tree 22 is generated follows in a subsequent portion of the description.

In the non-limiting example as shown in FIG. 2, when a music modal tab 20 is selected, the directory tree 22 containing a set of music branches 25 is shown. Each music branch 25 may define a node for storing music files categorized by metadata in a hierarchical fashion as per the disclosure of U.S. Pat. No. 6,928,433. For example, the set of music branches 25 may include, as shown for illustrative purposes, playlist, album, artist, genre, all tracks, folders, DJ, transfer list or the like.

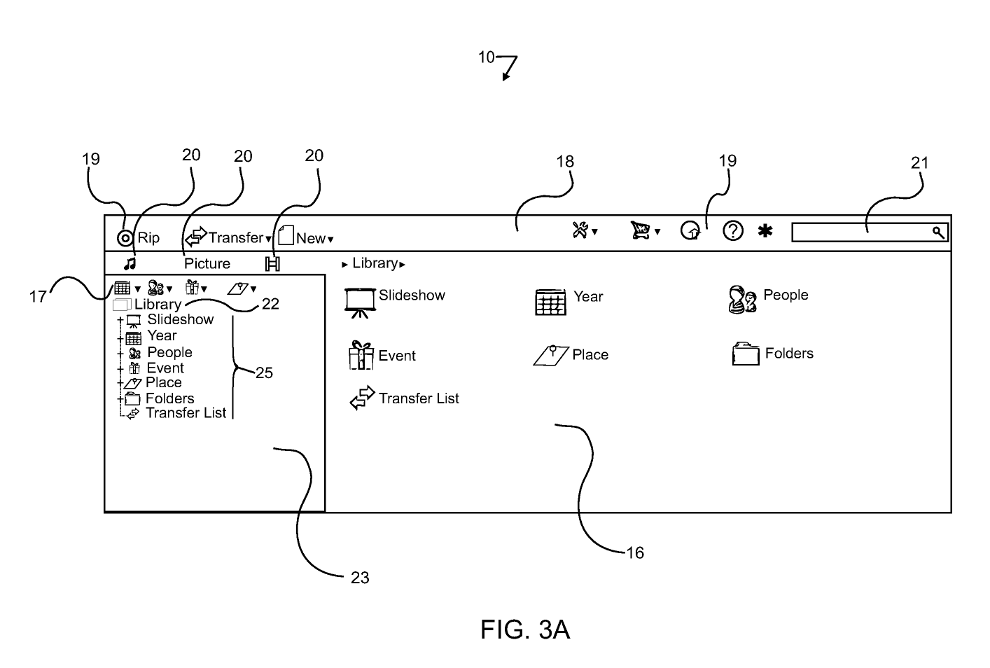

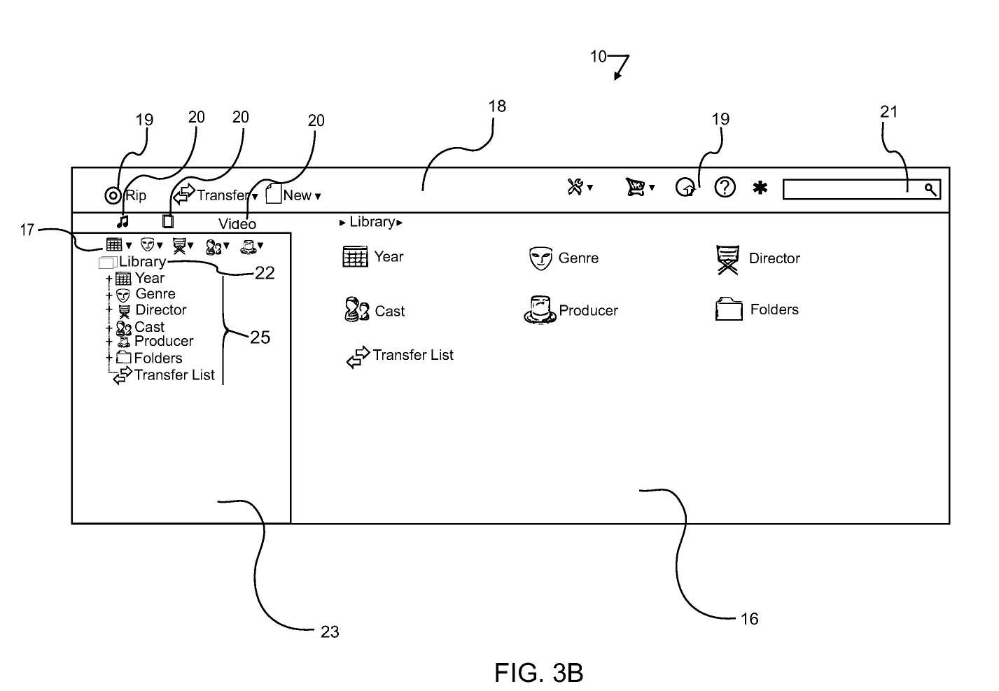

FIGS. 3a, and 3b illustrate other non-limiting examples of the interface 10 when a picture modal tab 20, and a video modal tab 20 are selected respectively. In FIG. 3a, a set of picture branches 25 may include, as shown for illustrative purposes, slideshow, year, people, event, place, folders, transfer list, or the like. Similarly, in FIG. 3b, a set of video branches 25 may include, as shown for illustrative purposes, year, genre, director, cast, producer, folders, transfer list, or the like.

FIG. 4 shows a process flow of the method 100 for generating the user interface 10 on the client device 14. Firstly, new metadata is provided to the metadata server in step 99. As such, the metadata is updated in the metadata server. The metadata server may be a part of server 12 or may be a separate server. The new metadata may be transmitted to the metadata server either via a push process (where the data server transmits any new metadata for new data to the metadata server) or a pull process (where the metadata server periodically/continually checks whether new data resides in the data server and consequently sends a request to the data server to transmit any new metadata). Subsequently, in step 101, the metadata in the metadata server is processed. Processing of the metadata may include analysis of the metadata on the server. Analysing the metadata may comprise determining a data file format such as, for example, an audio file, an image file, a video file and so forth. Analysing the metadata enables categorization of data into a hierarchy in accordance with the branches 25 of each directory tree 22 as presented in the primary window 23 of the user interface 10.

In step 102, the user sends a request using the user interface 10 on the client device 14 to the server 12 to perform a task such as for example, to view one data file or to access a collection of music files, where the files are stored on the server 12. This may be done by selecting the music modal tab 20 in the user interface 10.

At step 103, the client device 14 consequently generates the user interface 10 based on the user's request for enabling access to data on the server 12 (data server). The server 12 (metadata server) sends the hierarchy of data to the client device 14. The client device 14 then renders a directory tree 22 based on hierarchy of data and a pre-defined protocol linking the client device 14 and the server 12. It should be noted that a hardware/software configuration of the client device 14 requires a minimum performance level to operate on the pre-defined protocol. A combination of the pre-defined protocol and the hardware/software configuration of the client device 14 determines how the data is consumed by the client device 14 (either via streaming or downloading). However, as mentioned earlier, it is advantageous that the client device 14 only requires low-end processing capability.

There is no requirement for an application on the client device 14 to send the data file or hierarchy information to the server 12. Advantageously, since the processing of metadata is done on the server 12 (metadata server) prior to sending to the client device 14, this minimizes a requirement for the client device 14 to have sophisticated processing power. Consequently, diminishing a need for high performance processors minimises the cost of producing each client device 14. In this regard, a need to adopt more advanced processors on a client device 14 is eradicated given that the major processing aspects are handled by the server 12. Consequently client device 14 obsolescence is minimized as the changing tasks and demands of the user may be controlled by the server 12. Thus, environmental friendly consumer patterns will emerge since usage of client devices 14 is prolonged.

Having now fully described the invention, it should be apparent to a person of ordinary skill in the art that many modifications can be made hereto without departing from the scope as claimed.

1. A method for generating a user interface for enabling access to data on a server comprising:
updating metadata in a metadata server, the metadata server being functionally connected to the server;
processing the metadata on the metadata server;
sending a request to the server to perform a task; and
generating the user interface on a client device based on the processed metadata for enabling access to data on the server.

2. The method according to claim 1, wherein processing the metadata comprises analysing the metadata on the metadata server.

3. The method according to claim 2, wherein analysing the metadata comprises determining a data file format selected from a group consisting of: {audio file, image file and video file}.

4. The method according to claim 2, wherein analysing the metadata enables categorization of data into a hierarchy in accordance with branches of a directory tree presented in the user interface.

5. The method according to claim 1, further comprising:
using the user interface to send the request to the server.

6. The method according to claim 1, wherein the task is selected from a group consisting of: {browsing a collection of files, organizing files, selecting files, editing files, uploading files, downloading files}.

7. The method according to claim 1, wherein the client device is selected from the group consisting of: {portable media player, mobile phone, Personal Digital Assistant (PDA), computing device}.

8. The method according to claim 1, wherein the server is separable into at least one data server and at least one metadata server.

9. The method according to claim 1, further including:
consuming the data based on a combination of a pre-defined protocol and a hardware/software configuration of the client device.

10. The method according to claim 1, wherein updating the metadata in the metadata server is either a push process by the server or a pull process by the metadata server.
